(19) United States
(12) Patent Application Publication
(10) Pub. No.: US 2023/0358332 A1
(43) Pub. Date: Nov. 9, 2023

(54) SAFETY RADIATOR CAP COVER WITH VALVE RELEASER

(71) Applicant: ZENOBIA INTERNATIONAL INVESTMENTS INC., Los Angeles, CA (US)

(72) Inventor: DEBBIE J. ROBINSON, Los Angeles, CA (US)

(21) Appl. No.: 17/736,061

(22) Filed: May 3, 2022

(51) Int. Cl. F16K 35/10

(52) U.S. Cl. CPC F16K 35/10

(57) ABSTRACT

The safety radiator cap cover with valve releaser provides protection from hot fluids for a person removing a cap with a pressure relief valve lever from an automotive radiator or other pressurized vessel. The cover includes a tapered handle across its top having side recesses to provide a firmer grip. The safety radiator cap cover includes an upper flange that directs the hot fluids predominately outward, and a lower flange that directs the hot fluid predominately downward. Inside the main body of the safety radiator cap cover is a cavity for receipt of the radiator cap. The valve releaser includes a wide pocket extending forward from the front end of the cavity for the receipt of the valve lever of the radiator cap. The rear end of the cavity includes a U-shaped recess for receipt of the radiator cap's rear tab to align the releaser with the lever.

### BACKGROUND

### 1. Field

The disclosure of the present patent application relates generally to caps for pressurized vessels, and particularly to a safety radiator cap cover with valve releaser.

### 2. Description of the Related Art

It is often required to access the interior of a radiator or other pressurized vessel to add additional liquids, such as water or coolant; to test certain parameters, such as specific gravity, etc. of the coolant; and/or to replace the liquids therein. As shown in FIGS. 6-7, a prior art radiator cap RC may include a pressure release valve RV that opens when the coolant reaches a predetermined maximum pressure. While the cap is installed on the radiator fill tube, the released coolant is usually directed down a side port of the radiator fill tube and is safely directed downward below the radiator. When the cap RC is removed, however, the pressurized and hot coolant can splash over the engine, and in worst case scenarios, can splash on the person removing the cap RC and cause serious burns. The radiator cap RC may also include a pressure valve release lever RL that allows the valve RV to be manually opened to vent the fluids prior to twisting the cap RC off of the radiator fill tube.

Radiator cap removing devices often include flanges to direct the hot fluids downward, away from the user. These flanges often are not designed to both slow down and direct the fluids downward and can create secondary splashing off of engine components, thereby creating an unsafe situation. In addition, such devices do not include any structure for releasing radiator cap pressure release valves while also covering the cap. Often, mechanics will use rags or towels to cover the cap while operating the release lever through the rag. As these rags and towels are porous, they soak up the hot liquids and become very hot, which may cause serious burns if they are contacted. Thus, a safety radiator cap cover with valve releaser solving the aforementioned problems is desired.

### SUMMARY

The safety radiator cap cover with valve releaser provides protection from hot fluids for a person removing a cap with a pressure relief valve lever from the fill tube of an automotive radiator or other pressurized vessel. The cover includes a tapered handle across its top with side recesses to provide a firmer grip. The safety radiator cap cover includes an upper flange that directs the hot fluids predominately outward, and a lower flange that directs the hot fluid predominately downward. Inside the main body of the safety radiator cap cover is a cavity for receipt of the radiator cap. The valve releaser includes a wide pocket at the front end of the cavity for placement over the valve lever of the radiator cap. The rear end of the cavity includes a U-shaped recess for receipt of the radiator cap's rear tab to align the releaser with the lever.

These and other features of the present subject matter will become readily apparent upon further review of the following specification and drawings.

### BRIEF DESCRIPTION OF THE DRAWINGS

FIG. 1: is an environmental perspective view of a safety radiator cap cover with valve releaser placed over a radiator cap mounted on a radiator fill tube.

FIG. 2: is a top view of the safety radiator cap cover with valve releaser of FIG. 1.

FIG. 3: is a bottom view of the safety radiator cap cover with valve releaser of FIG. 1.

FIG. 4: is a side view of the safety radiator cap cover with valve releaser of FIG. 1.

FIG. 5: is a section view taken along lines 5-5 of FIG. 2.

FIG. 6 is a top view of an exemplary prior art radiator cap with a release valve lever of the prior art.

FIG. 7 is a side view of the prior art radiator cap of FIG. 6.

Similar reference characters denote corresponding features consistently throughout the attached drawings.

### DETAILED DESCRIPTION OF THE PREFERRED EMBODIMENTS

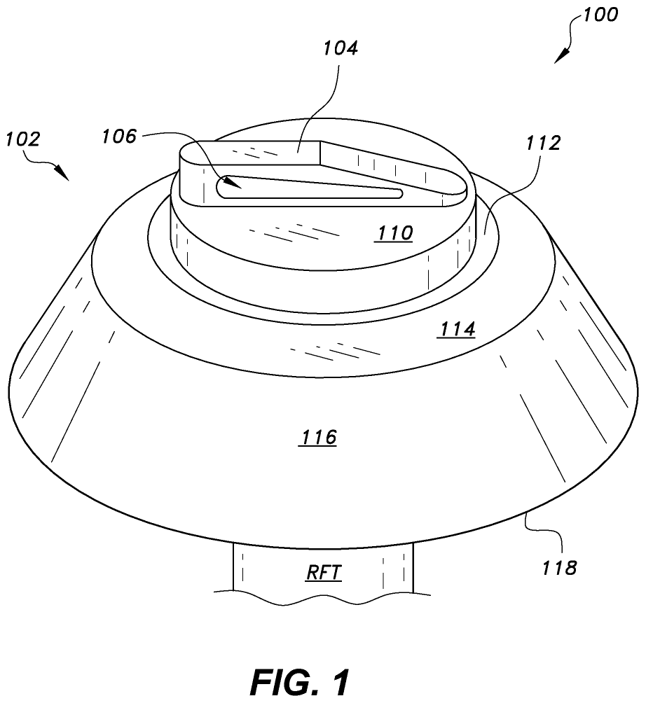

In FIG. 1, the safety radiator cap cover with valve releaser 100 is shown covering a radiator cap mounted on a radiator fill tube RFT. The radiator cap cover 100 includes a cover body 102 with an integral handle 104. The handle 104 tapers from a first height at its front end to a second lower height at its rear end, and includes finger grip concave recesses 106 along its side surfaces. The cover body 102 includes a radiator cap housing 108 with a top surface 110 attached to and integral with the handle 104. A horizontally extending radial flange 112 is attached to and integral with the lower outer edge of the cap housing 108. An upper predominately outwardly extending slanted flange 114 is attached to and integral with the outer edge of the horizontally extending radial flange 112. A lower predominately downwardly extending slanted flange 116 is attached to and integral with the lower outer edge of the upper slanted flange 114 and includes a tapered lower edge 118. The safety radiator cap cover 100 completely covers the radiator cap (not shown in FIG. 1) and the upper portion of the radiator fill tube RFT to provide protection from hot fluids for a person removing the cap 100 from the radiator fill tube RFT.

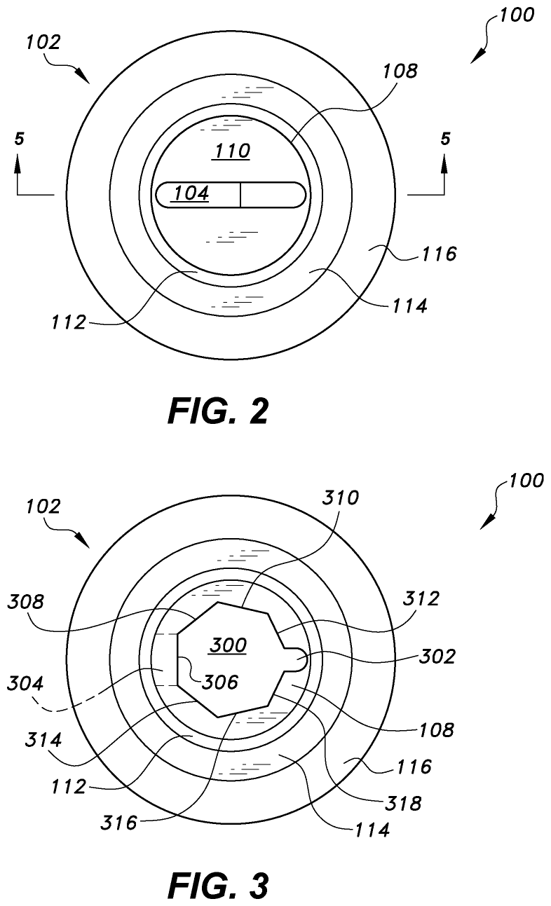

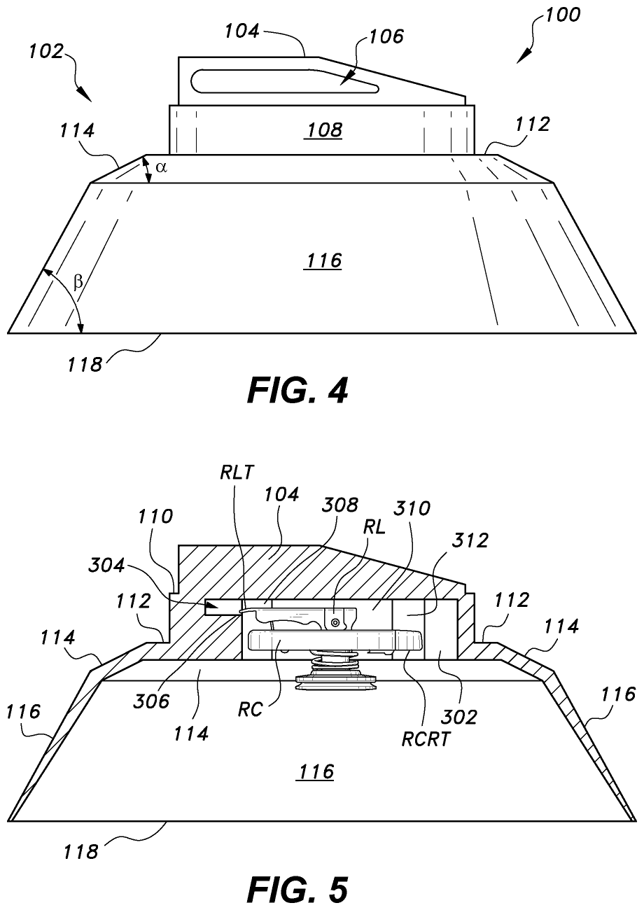

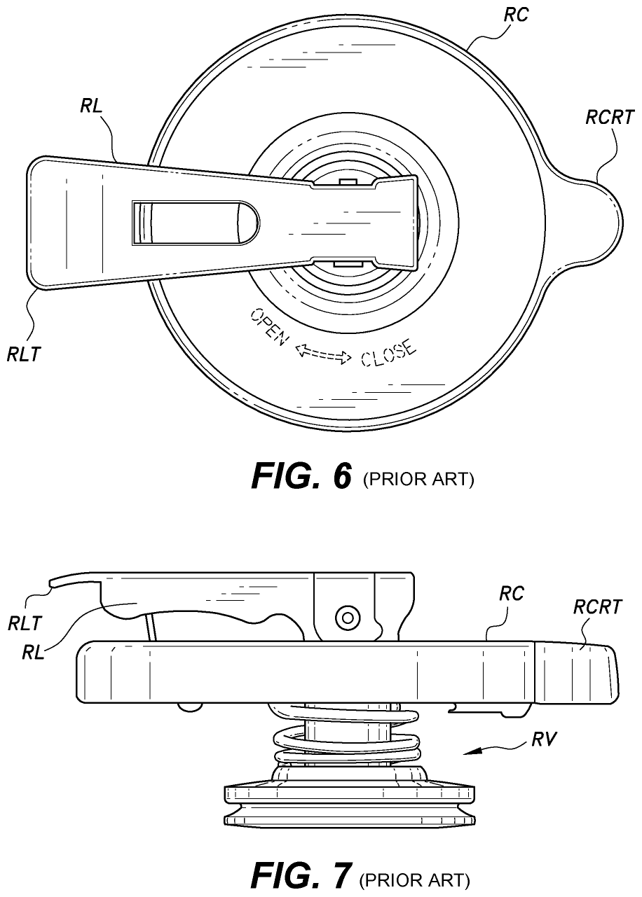

The details of the safety radiator cap cover with valve releaser 100 are shown in FIGS. 2-5. As best seen in FIG. 4, the upper predominately outwardly extending slanted flange 114 extends at angle α relative to the horizontal (or the plane of the lower edge 118 of the lower slanted flange 116), while the lower predominately downwardly extending slanted flange 116 extends at angle β relative to the horizontal. In one embodiment, the angle α is between 15° and 45° degrees (shown as 30°) and the angle β is between 45° and 75° degrees (shown as 60°). This double flange structure slows down the hot fluids by the fluids first contacting the upper slanted flange 114 that deflects the fluids predominately outward and toward the lower slanted flange 116, which then deflects the fluids predominately downward and away from the user. The resulting direction of fluid flow is predominately below the cover 100, therefore maximizing protection for the user.

As is shown in FIGS. 3 and 5, the radiator cap housing 108 includes a central recess 300 opening downward for receiving and covering a radiator cap RC. The rear end of the recess 300 includes a rear U-shaped radiator cap alignment recess 302 for receiving the radiator cap rear tab RCRT for alignment purposes, as described below. The front end of the recess 300 includes a front radiator cap release lever pocket 304 extending forward into the body of the radiator cap housing at the top end of the central recess 300, the pocket having an opening into the central recess 300 and a rear lip 306 for engagement of the tip RLT of the radiator cap pressure release lever RL of the radiator cap RC. The recess 300 further includes a front left sidewall 308, a left sidewall 310, a rear left sidewall 312 a front right sidewall 314, a right sidewall 316, and a rear right sidewall 318. The sidewalls 308, 310, 312, 314, 316, 318 form a substantially hexagonal recess 300 for engaging the circular outer portion of the radiator cap RC when the user turns the cover 100 and the cap RC to remove the radiator cap RC from the radiator fill tube RFT.

In use, a user first places the safety radiator cap cover 100 over the radiator cap RC such that the radiator cap RC is within the central recess 300. By then pushing the cover 100 forward, the the radiator cap rear tab RCRT enters the rear U-shaped radiator cap alignment recess 302, thereby aligning the front radiator cap release lever pocket 304 with the tip RLT of the radiator cap pressure release lever RL. The cover 100 is then pulled backward until the tip RLT of the radiator cap pressure release lever RL enters the pocket 304. Once in this position, the user firmly grips the handle 104 and pulls upward such that the rear lip 306 of the pocket 304 lifts up on the tip RLT of the release lever RL, thereby rotating the lever RL upward and opening the pressure release valve RV. The cover 100 and radiator cap RC may the be rotated to remove the radiator cap RC from the radiator fill tube RFT.

It should be understood that while the safety radiator cap cover with valve releaser 100 is shown with a substantially cylindrical radiator cap housing 108, a circular ring-shaped horizontally extending radial flange 112 and frustoconical slanted flanges 114, 116, other shapes are contemplated and the safety radiator cap cover with valve releaser 100 is not limited to these specific shapes. In addition, the various components of the the radiator cap cover 100 may be separate components attached to one another or may be formed integrally with one another to produce a one-piece cover 100 using injection molding, for example.

It is to be understood that the safety radiator cap cover with valve releaser is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A safety radiator cap cover, comprising:
a cover body having:
a radiator cap housing having a top surface and a lower outer edge;
a radial flange attached to and extending horizontally from the lower outer edge of the cap housing, the radial flange having an outer edge;
an upper slanted flange attached to the outer edge of the radial flange, the upper slanted flange extending predominately outward and having a lower outer edge; and
a lower slanted flange attached to the lower outer edge of the upper slanted flange, the lower slanted flange extending predominately downward and having a lower edge defining a plane, the upper slanted flange extending at a first angle relative to the plane of the lower edge of the lower slanted flange, the lower slanted flange extending at a second angle relative to the plane of its lower edge, the second angle being greater than the first angle; and
a handle attached to the top surface of the radiator cap housing.

2. The safety radiator cap cover as recited in claim 1, wherein
the first angle is between 15° and 45°; and
the second angle is between 45° and 75°.

3. The safety radiator cap cover as recited in claim 1, wherein the radiator cap housing further comprises a central recess opening downward for covering the radiator cap, the central recess including:
a rear end;
a front end having an opening into a valve releaser define therein; and
a plurality of sidewalls extending between the front end and the rear end.

4. The safety radiator cap cover as recited in claim 3, wherein the valve releaser comprises a front radiator cap release lever pocket extending forward into the cover body, the pocket having a rear lip.

5. The safety radiator cap cover as recited in claim 4, wherein the central recess further comprises a U-shaped radiator cap alignment recess at the rear end of the central recess.

6. The safety radiator cap cover as recited in claim 5, wherein the plurality of sidewalls of the central recess comprises a front left sidewall, a left sidewall, a rear left sidewall, a front right sidewall, a right sidewall, and a rear right sidewall, the sidewalls being joined together to define the central recess, the central recess being substantially hexagonal.

7. The safety radiator cap cover as recited in claim 6, wherein the handle has a front end, a rear end, and a height tapering from a first height at the front end of the handle to a lower second height at the rear end of the handle.

8. The safety radiator cap cover as recited in claim 7, wherein the handle has side surfaces having concave finger grip recesses defined therein.

9. The safety radiator cap cover as recited in claim 8, wherein the radiator cap housing, the radial flange, the upper slanted flange, the lower slanted flange, and the handle are all integral to one another, such that the safety radiator cap cover is formed in one-piece.

10. A safety radiator cap cover with valve releaser, comprising a cover body having:
a radiator cap housing including:
a top surface;
a lower outer edge;
a central recess having a rear end, a front end having an opening into a valve releaser defined therein, and a plurality of sidewalls extending between the front end and the rear end; and
at least one slanted flange attached to the lower outer edge of the radiator cap housing; and
a handle attached to the top surface of the radiator cap housing.

11. The safety radiator cap cover with valve releaser as recited in claim 10, wherein the valve releaser comprises a front radiator cap release lever pocket extending forward from the central recess into the cover body, the pocket having a rear lip.

12. The safety radiator cap cover with valve releaser as recited in claim 11, wherein the central recess further comprises a U-shaped radiator cap alignment recess at the rear end of the central recess.

13. The safety radiator cap cover with valve releaser as recited in claim 12, wherein the plurality of sidewalls of the central recess comprises a front left sidewall, a left sidewall, a rear left sidewall, a front right sidewall, a right sidewall, and a rear right sidewall, the sidewalls being joined together to define the central recess, the central recess being substantially hexagonal.

14. The safety radiator cap cover with valve releaser as recited in claim 13, wherein the handle has a front end, a rear end, and a height tapering from a first height at the front end of the handle to a lower second height at the rear end of the handle.

15. The safety radiator cap cover with valve releaser as recited in claim 14, wherein the handle has side surfaces having concave finger grip recesses defined therein.

16. The safety radiator cap cover with valve releaser as recited in claim 10, wherein the radiator cap housing, the at least one slanted flange, and the handle are all integral to one another, such that the safety radiator cap cover with valve releaser is formed in one-piece.

17. The safety radiator cap cover with valve releaser as recited in claim 10, further comprising a radial flange attached to the lower outer edge of the cap housing and extending horizontally therefrom, the radial flange having an outer edge attached to the at least one slanted flange to attach the at least one slanted flange to the lower outer edge of the radiator cap housing.

18. The safety radiator cap cover with valve releaser as recited in claim 17, wherein the at least one slanted flange comprises:
an upper slanted flange attached to the outer edge of the radial flange, the upper slanted flange extending predominately outward and having a lower outer edge; and
a lower slanted flange attached to the lower outer edge of the upper slanted flange, the lower slanted flange extending predominately downward and having a lower edge defining a plane, the upper slanted flange extending at a first angle relative to the plane of the lower edge of the lower slanted flange, the lower slanted flange extending at a second angle relative to the plane of its lower edge, the second angle being greater than the first angle.

19. The safety radiator cap cover with valve releaser as recited in claim 18, wherein
the first angle is between 15° and 45°; and
the second angle is between 45° and 75°.
